(19) United States
(12) Patent Application Publication
(10) Pub. No.: US 2011/0172849 A1
(43) Pub. Date: Jul. 14, 2011

(54) CONTROL NETWORK FOR MOTOR VEHICLES

(76) Inventors: Calin Augustin Rotaru, Stuttgart (DE); Robert Erhart, Ditzingen (DE)

(21) Appl. No.: 13/001,959

(22) PCT Filed: Apr. 30, 2009
(86) PCT No.: PCT/EP09/55256

§ 371 Date: Mar. 30, 2011

(30) Foreign Application Priority Data
Jun. 30, 2008 (DE) 10 2008 040 024.6

(51) Int. Cl. G06F 17/00

(52) U.S. Cl. 701/1

(57) ABSTRACT

A control network for motor vehicles, having nodes in the form of control devices, sensors, and/or actuators, that are connected to each other and temporally synchronized by a time-controlled bus, wherein each node has a time reference system synchronized with the bus, that indicates a global time shared by all nodes, and at least one node has a time coordination system that, for a plurality of actions to be implemented by different nodes, coordinates the global times at which these actions are to be implemented.

### FIELD OF THE INVENTION

The present invention relates to a control network for motor vehicles, having nodes in the form of control devices, sensors, and/or actuators, that are connected to each other and temporally synchronized by a time-controlled bus.

### BACKGROUND INFORMATION

German Published Patent Application No. 103 40 165 describes a control network of this type, which has a sensor and a control device, for example. The sensor and the bus are synchronized in order to control the measuring times of the sensor such that the results obtained after each measuring cycle may be transmitted with the minimum possible delay via a free time slot of the bus, so that the measurement data, when they arrive in the control device, are still as current as possible.

### SUMMARY

Example embodiments of the present invention use the time-controlled bus not only to synchronize the network nodes with the bus, but also to synchronize the network nodes with each other, and, building on this, to coordinate temporally the actions to be implemented by different nodes.

For example, example embodiments of the present invention make it possible to coordinate temporally the measurement cycles of a plurality of sensors, for example, of two or of a plurality of radar sensors, such that mutual signal interferences are avoided.

If the network contains different actuators, for example, for automatic interventions in the drive system, the braking system, and/or the steering of the vehicle as part of an automatic distance and speed control system, an electronic stability system (ESP), a predictive safety system (PSS) for avoiding collisions or for minimizing the consequences of the collision, and the like, example embodiments of the present invention make it possible to coordinate temporally the actions of the different actuators such that undesired interactions are avoided.

In motor vehicle technology, there is an increasing tendency to network different control and assistance functions with each other. In this connection, example embodiments of the present invention may also be used to coordinate the actions of different signal evaluation devices and control devices such that each control device provides the results or partial results calculated by it, which are also required by other control devices, in the most timely manner possible.

Example embodiments of the present invention are illustrated in the drawing and explained in greater detail in the following description.

### BRIEF DESCRIPTION OF THE DRAWINGS

FIG. 1 is a block diagram of a control network according to an example embodiment of the present invention.

FIG. 2 illustrates a simplified communication protocol of a FlexRay bus, via which different nodes of the control network communicate with each other.

FIG. 3 is a sketch of a driving situation to explain the manner of functioning of the network.

FIG. 4 illustrates an example of an action table created by a time coordination system.

### DETAILED DESCRIPTION

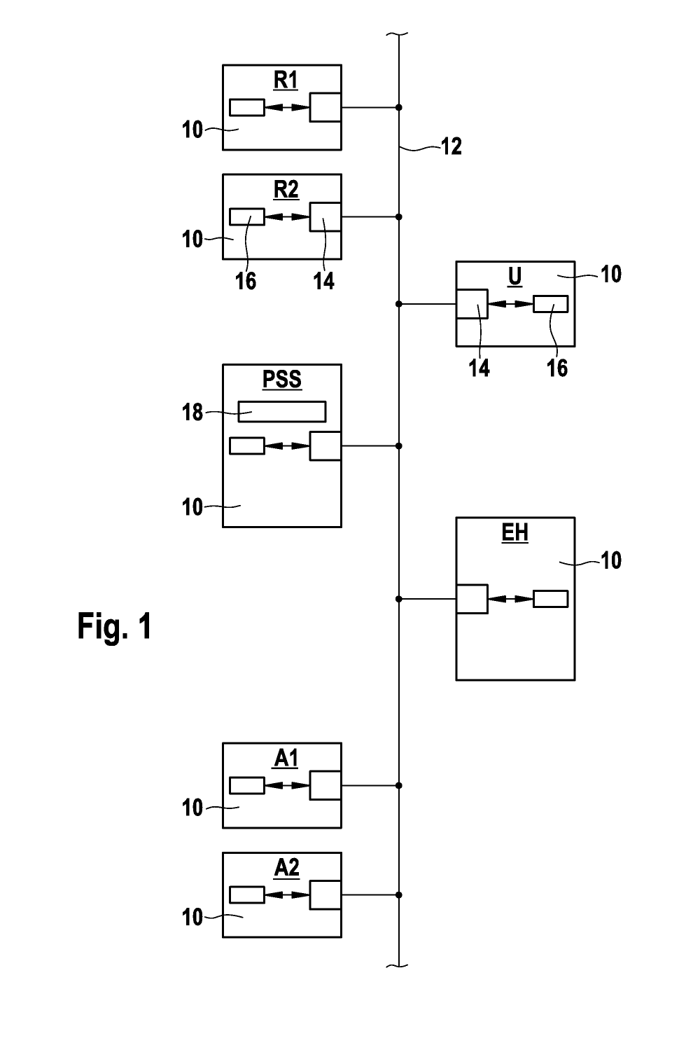

The control network illustrated in FIG. 1 includes a number of nodes 10, which are connected to each other by a time-controlled bus 12 (e.g., a deterministic bus such as FlexRay or the like). Nodes 10 are sensors, control devices, and actuators that are required for different assistance and safety functions in a motor vehicle. In the illustrated example, the sensors include two radar sensors R1 and R2 that are used to locate more distant objects (e.g., preceding vehicles) ahead of the host vehicle, and a system of ultrasonic sensors U that are used to locate objects at short range.

Two additional nodes 10 are control devices, namely a control device PSS for implementing safety functions (pre-crash) and a control device EH for an electronic parking assistance on the basis of the signals of ultrasonic sensors U.

Additional nodes 10 of the network are actuators A1 and A2, for example, for activating safety belt tighteners and for pre-activating airbags under the control of control device PSS.

Each node 10 has a bus interface 14, via which it communicates with bus 12, and that contains a bus time reference system synchronized with bus 12.

In the illustrated example, each node 10 additionally has a local time reference system 16, which is able to synchronize itself with bus time reference system 14, however, as indicated by double arrows in FIG. 1.

At least one of the nodes, control device PSS in the illustrated example, additionally has a time coordination system 18, which is used to coordinate temporally the actions to be implemented by the different nodes. This is possible despite a spatial separation of actuators 10, because time reference systems 14, 16 of all actuators display the same global time due to the synchronization with bus 12, so that the implementation times of all of the different actions may be related to the same global time.

In example embodiments, the function of time coordination system 18 may be distributed among a plurality of nodes.

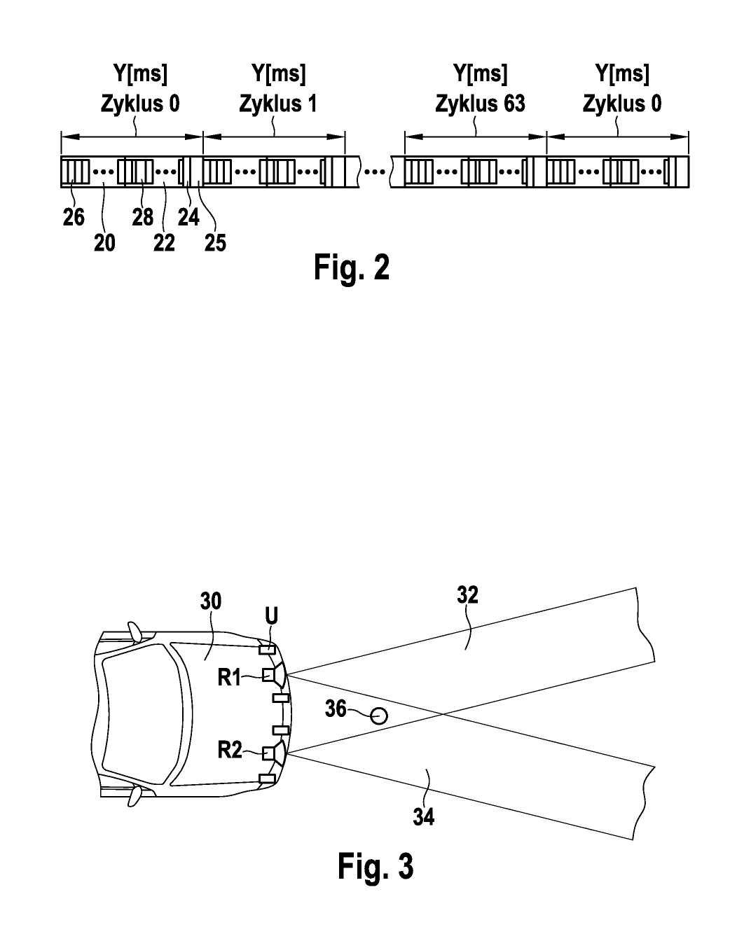

FIG. 2 shows a typical communication protocol of a time-controlled bus 12. In this instance, the protocol for a FlexRay bus is shown as an example. This protocol includes 64 cycles, which respectively have a specific cycle time Y (dependent on the global cluster parameter GCP, for example, 5 ms). Each cycle is subdivided into a static segment 20, a dynamic segment 22, a symbol segment 24 (symbol window segment), and an idle time 25 (network idle time), which is used by the bus as a buffer for the local time synchronization of the controller. Static segment 20 contains slots 26 having a fixed length, which are respectively assigned to one of the nodes 10. Dynamic segment 22 contains slots 28, whose length can vary dynamically, depending on requirements.

The data to be sent by individual nodes 10 or their bus interfaces are combined into “frames,” which are distributed among the slots assigned to the relevant nodes. The distribution may vary from cycle to cycle. After the end of cycle number 63, a new sequence begins with cycle 0, and the distribution of the frames repeats with the period of 64 cycles.

Each frame has a cycle counter in the header. The synchronization of the time basis of interfaces 14 (controller) takes place automatically and is part of the FlexRay specification.

A “start new cycle” trigger signal and the cycle count values thus define together a uniform and coherent time reference over a time span of 64 * Y ms.

If the actions of the different nodes that are to be coordinated all lie in the same interval of 64 * Y ms, then the bus time reference system provided by bus interfaces 14 consequently suffices. If actions are to be planned and temporally coordinated over longer time periods, then a global time reference may be achieved in that local time reference systems 16 synchronize again and again with bus time reference system 14. For this purpose, for example, time coordination system 18 may cyclically set a “global time” on the bus, within the 64 * Y ms.

FIG. 3 illustrates schematically the front end of a motor vehicle 30, which is equipped with the control network described here. Radar sensors R1 and R2, their locating ranges 32, 34, and ultrasonic sensors U are illustrated symbolically. Furthermore, an object 36 is shown, which could be a potential obstacle, which possibly requires a triggering of actuators A1 and A2.

Shortly before the time illustrated in FIG. 3, object 36 was still situated in locating ranges 32, 34 of both radar sensors R1 and R2, so that it was detected with the aid of the radar sensor system of control device PSS. However, it cannot be decided with the aid of the radar echoes alone whether object 36 is an actual obstacle or an insignificant object such as a tin can lying on the road or the like.

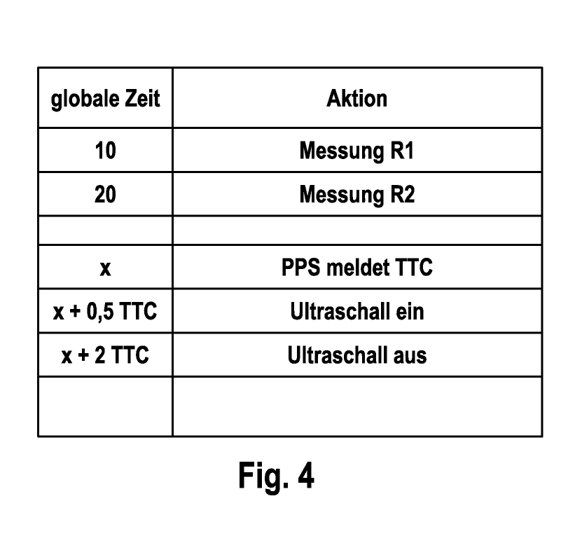

In the situation illustrated in FIG. 3, object 36 is already situated in the blind spot of the two locating ranges 32, 34, so that it can no longer be detected by the radar sensor system. In the application case illustrated in this instance as an example only, ultrasonic sensors U, which are actually provided for the parking assistance, are now to be used to qualify object 36 more closely and to monitor it at close range. The corresponding timing is illustrated schematically in FIG. 4.

FIG. 4 shows an action table, which is created and continually updated by time coordination system 18, for example. The global time is specified in the left column, e.g., in milliseconds, and the associated actions and events that are to be implemented by the different nodes of the network are listed in the right column. Thus, for example, radar sensor R1 performs its measurement at global time 10, while radar sensor R2 performs its measurement at global time 20. Although this is not illustrated in more detail in FIG. 4, this table is continued such that radar sensor R1 performs its measurements at times 30, 50, 70, etc., and radar sensor R2 does so at times 40, 60, 80, etc.

This alternation of the measurements using the two radar sensors R1 and R2 ensures that the signals sent and received by the different radar sensors do not interfere with each other.

Furthermore, in FIG. 4 an event is illustrated that takes place at some global time x not previously fixed and consists in control device PSS, which monitors object 36 with the aid of the radar signals, determining that the object can no longer be located (because it is now situated in the blind spot). At this time, control device PSS calculates the so-called “time to collision” TTC that indicates the time that will probably elapse from the current moment until object 36, if it is a real obstacle, collides with vehicle 30. Thereupon, time coordination system 18 ensures that ultrasonic sensors U are switched on at a somewhat later point in time, in the illustrated example at x+0.5 TTC (although the parking assistance function is not in operation).

If the ultrasonic sensors also locate object 36, it must be assumed that it is a real obstacle, and then actuators A1 and A2 are triggered at precisely calculated times, again under the control of time coordination system 18. If the ultrasonic sensors cannot locate object 36, because it was a small, irrelevant object, time coordination system 18 ensures that the ultrasonic sensors are switched off again at a time that is significantly later than the expected impact time, for example, at x+2 TTC.

1 to 5. (canceled).

6. A control network for a motor vehicle, comprising:
nodes in the form of at least one of (a) control devices, (b) sensors, and (c) actuators connected to each other and temporally synchronized by a time-controlled bus;
wherein each node has a time reference system synchronized with the bus, which indicates a global time shared by all nodes, and at least one node has a time coordination system that, for a plurality of actions to be implemented by different nodes, coordinates the global times at which these actions are to be implemented.

7. The control network according to claim 6, wherein the bus includes a deterministic bus.

8. The control network according to claim 7, wherein the time coordination system is adapted to coordinate actions of nodes whose global implementation times are separated by more than a duration of one cycle of the bus.

9. The control network according to claim 6, wherein at least two of the nodes include sensors, and the time coordination system is adapted to coordinate measuring times of the sensors such that they do not interfere with each other.

10. The control network according to claim 9, wherein the sensors are arranged as at least one of (a) radar sensors and (b) ultrasonic sensors.
